(19) United States
(12) Patent Application Publication
(10) Pub. No.: US 2021/0370498 A1
(43) Pub. Date: Dec. 2, 2021

(54) Assembly for a Robot, and Robot Device

(71) Applicants: Futaba Corporation, Mobara-shi (JP); Chiba Institute of Technology, Narashino (JP)

(72) Inventors: Shotaro KUDO, Mobara-shi (JP); Yasuyuki SUZUKI, Mobara-shi (JP); Toru KONO, Mobara-shi (JP); Ryosei KURAMOTO, Mobara-shi (JP); Hidetoshi MURAMATSU, Mobara-shi (JP); Takayuki FURUTA, Narashino (JP); Masaharu SHIMIZU, Narashino (JP); Hideaki YAMATO, Narashino (JP); Yuu OKUMURA, Narashino (JP)

(21) Appl. No.: 17/329,403

(22) Filed: May 25, 2021

(30) Foreign Application Priority Data
May 26, 2020 (JP) 2020-091358

(51) Int. Cl. B25J 9/08; B25J 19/00; B25J 15/04

(52) U.S. Cl. CPC B25J 9/08; B25J 15/045; B25J 19/0029

(57) ABSTRACT

The present invention provides a main body with a coupling section, wherein the circuit board includes terminals for power supply and for signal, wherein the coupling section has a first positioning section and a second positioning section, and wherein the assembly is configured so that in a state where positioning has been performed by the first positioning section, positioning by the second positioning section is performed and the coupling section is coupled to another coupling section of another main body. Thus, coupling the coupling section is performed in the state where positioning has been performed, wherein connection of the terminals for power supply and for signal to power supply and signal terminal sections is performed in this state, which may enable the operability for coupling a coupling section to be improved while ensuring a mechanically and electrically correct coupled state.

### CROSS-REFERENCE TO RELATED APPLICATION

This application claims the priority benefit of Japanese Patent Application No. 2020-091358 filed May 26, 2020, which is fully incorporated herein by reference.

### BACKGROUND OF THE INVENTION

### Technical Field

The present invention relates to the technical field related to an assembly for a robot which is coupled and used as a joint for a robot and/or an arm for a robot, and to a robot device with an assembly for a robot.

### Background Art

In recent years, the automation in industries has progressed, and the development of various robot devices is desired which facilitate the automation, wherein robot devices have different structures and/or features depending on their industrial applications.

Such robot devices include e.g. a robot type which is formed by coupling multiple assemblies for a robot, the assemblies being intended for use as joints for a robot and/or arms for a robot, wherein this type is referred to as so-called “articulated robot”. Some articulated robots are capable of being adapted for the application by changing the coupled state of assemblies (see e.g. Patent Document 1).

A robot device according to Patent Document 1 is constituted from three assemblies (units) for a robot, wherein the three assemblies are coupled in a successive manner.

### CITATION LIST

Patent Literature

Patent Document 1: JPH 8-19985 A

### SUMMARY OF THE INVENTION

For such a robot device, e.g. in the case where maintenance is necessary and/or a fault has occurred, it is necessary to perform a decoupling operation for decoupling the assemblies from each other and a subsequent coupling operation. However, these operations often require specialized skills, which results in drawbacks that it is difficult to perform these operations by a user of the robot device by himself/herself.

Due to the difficulty for performing coupling operation etc. by the user of the robot device by himself/herself, it is necessary to request a specialized service provider to do such operation, which makes it impossible to activate the robot device during the request and this operation, wherein for example the downtime in which the activation is not possible is increased and the productivity is reduced.

On the other hand, after the coupling operation of the assemblies to each other has been completed, it is necessary to ensure a correct coupled state between the assemblies in order to achieve a good operation of the robot device.

Therefore, an objective of the present invention is to provide an assembly for a robot and a robot device which may enable the operability for coupling a coupling section to be improved while ensuring a mechanically and electrically correct coupled state.

First, an assembly for a robot according to the present invention includes a main body with a coupling section, the coupling section including a first positioning section and a second positioning section, wherein the assembly is configured so that in a state where positioning has been performed by the first positioning section, positioning by the second positioning section is performed and the coupling section is coupled to another coupling section of another main body.

In this manner, the coupling section is coupled in the state where positioning has been performed by the second positioning section, following the state where positioning has been performed by the first positioning section.

Second, preferably for the assembly according to the present invention as described above, where a coupling direction of the coupling section is defined as an axial direction, the assembly is configured so that positioning in a direction of rotation around an axis is performed by the first positioning section, and positioning in both of the axial direction and the direction of rotation around the axis is performed by the second positioning section.

In this manner, positioning is performed by different positioning sections for the direction of rotation around the axis and the axial direction individually.

Third, preferably for the assembly according to the present invention as described above, the coupling section has a coaxial guiding surface which is configured for causing an axis to coincide with an axis of the another coupling section.

In this manner, when coupling the coupling section to the another coupling section, the coaxial guiding surface allows the axis of the coupling section to coincide with the axis of the another coupling section.

Fourth, preferably for the assembly according to the present invention as described above, the first positioning section includes two first alignment elements which are spaced in the direction of rotation around the axis, and the second positioning section includes three or more second alignment elements which are spaced in the direction of rotation around the axis, wherein the assembly is configured so that in the state where positioning in the direction of rotation around the axis has been performed by the first positioning section, positioning in both of the axial direction and the direction of rotation around the axis is performed by the second positioning section.

In this manner, positioning in the direction of rotation around the axis is performed by first positioning sections with two alignment elements for each one and by second positioning sections with three or more alignment elements for each one in a successive manner.

Fifth, preferably for the assembly according to the present invention as described above, it includes a circuit board mounted to the coupling section, wherein the circuit board includes a terminal for power supply and a terminal for signal, wherein when coupling the coupling section to the another coupling section, the terminal for power supply and the terminal for signal are configured to be connected to respective terminal sections on a circuit board mounted to the another coupling section.

In this manner, in the state where positioning has been performed by the first positioning section and the second positioning section, the coupling section is coupled and the terminals for power supply and for signal are connected to the respective terminal sections.

Sixth, preferably for the assembly according to the present invention as described above, the terminal for power supply and the terminal for signal share a common ground, wherein when coupling the coupling section to the another coupling section, connection of the terminal for signal to a terminal section on the circuit board mounted to the another coupling section is performed in a state where the terminal for power supply has been connected to a terminal section.

In this manner, connection of the terminal for signal to the signal terminal section is performed after the terminal for power supply has been connected to the power supply terminal section, whereby connection of the terminal for signal to the power supply terminal section can be performed in a state where connection to the ground has been stabilized.

Seventh, preferably for the assembly according to the present invention as described above, the main body includes a fastening ring rotatably supported thereon, the fastening ring having a thread groove, wherein in a state where the coupling section has been coupled to the another coupling section, the thread groove is configured to be screwed with the another coupling section by rotating the fastening ring in one direction.

In this manner, the coupling section is fixed to the another coupling section by rotating the fastening ring relative to the main body in a state where the coupling section has been positioned.

Eighth, preferably for the assembly according to the present invention as described above, the assembly is configured so that the terminal for power supply and the terminal for signal are disconnected from the respective terminal sections by the coupling section being separated from the another coupling section which accompanies rotation of the fastening ring in another direction.

In this manner, the fixed state between the coupling section and the another coupling section as well as the connected state of the terminal for power supply and the terminal for signal to the respective terminal sections are released by a single operation.

Ninth, preferably for the assembly according to the present invention as described above, it includes a first coupling section and a second coupling section as the coupling section, each of the first coupling section and a second coupling section being capable of coupling to another coupling section of the another assembly.

This enables each of the first coupling section and the second coupling section to be coupled to another assembly for a robot in a successive manner.

Tenth, preferably for the assembly according to the present invention as described above, a coupling direction of the first coupling section is orthogonal to a coupling direction of the second coupling section.

This enables each of the first coupling section and the second coupling section to be coupled to another assembly for a robot in directions orthogonal to each other.

Eleventh, preferably for the assembly according to the present invention as described above, a coupling direction of the first coupling section is opposite to a coupling direction of the second coupling section.

This enables each of the first coupling section and the second coupling section to be coupled to another assembly for a robot in opposite directions.

Twelfth, a robot device according to the present invention includes a plurality of assemblies for a robot which are coupled in a successive manner, wherein each of the assemblies includes a main body with a coupling section, the coupling section having a first positioning section and a second positioning section, wherein the assembly is configured so that in a state where positioning has been performed by the first positioning section, positioning by the second positioning section is performed and the coupling section is coupled to another coupling section of another main body.

In this manner, for the assemblies for a robot, coupling the coupling sections is performed in a state where positioning has been performed by the second positioning section, following the state where positioning has been performed by the first positioning section.

According to the present invention, coupling the coupling section is performed in the state where positioning has been performed by the positioning sections, wherein connection of the terminal for power supply and the terminal for signal to the respective terminal sections is performed in this state, which may enable the operability for coupling a coupling section to be improved while ensuring a mechanically and electrically correct coupled state.

### BRIEF DESCRIPTION OF THE DRAWINGS

FIG. 1 shows embodiments of an assembly for a robot and a robot device according to the present invention together with FIGS. 2 to 13, wherein FIG. 1 shows a schematic perspective view illustrating the robot device;

FIG. 2 shows an exploded perspective view of the assembly;

FIG. 3 shows a perspective view for the assembly;

FIG. 4 shows a second circuit board and others;

FIG. 5 shows an enlarged sectional view illustrating that a fastening ring has been screwed on;

FIG. 6 shows a sectional view of a fixed section;

FIG. 7 shows a first circuit board and others;

FIG. 8 shows a perspective view illustrating two assemblies for a robot which are coupled;

FIG. 9 shows a sectional view illustrating a state immediately after starting to couple the assemblies;

FIG. 10 shows a sectional view illustrating a state following that of FIG. 9 where a terminal for power supply has been connected to a power supply terminal section while a terminal for signal is not connected to a signal terminal section;

FIG. 11 shows a sectional view illustrating a state following that of FIG. 10 where positioning in an axial direction and a direction of rotation around an axis has been performed and the terminal for signal has been connected to the signal terminal section;

FIG. 12 shows a sectional view illustrating a state following that of FIG. 11 where the assembly has been fixed to another assembly via a fastening ring; and

FIG. 13 shows a sectional view illustrating a state where a pressed surface of the fastening ring has been pressed against an O-ring.

### DETAILED DESCRIPTION OF THE PREFERRED EMBODIMENTS

Hereinafter, embodiments for an assembly for a robot and a robot device according to the present invention will be described with reference to the attached Drawings.

The embodiments as shown below illustrates an example where a robot device according to the present invention is applied to a type which is installed and used on a floor or others. However, a coverage of the robot device according to the present invention is not limited to such a type which is installed and used on a floor or others, but may be applied to types which are mounted and used on a ceiling and/or a wall surface.

It is to be noted that directional terms such as “front”, “back”, “upward”, “downward”, “right”, “left” or the like are merely intended for better understanding, and the present invention is not limited to such directions in its implementation.

<Schematic Structure of A Robot Device>

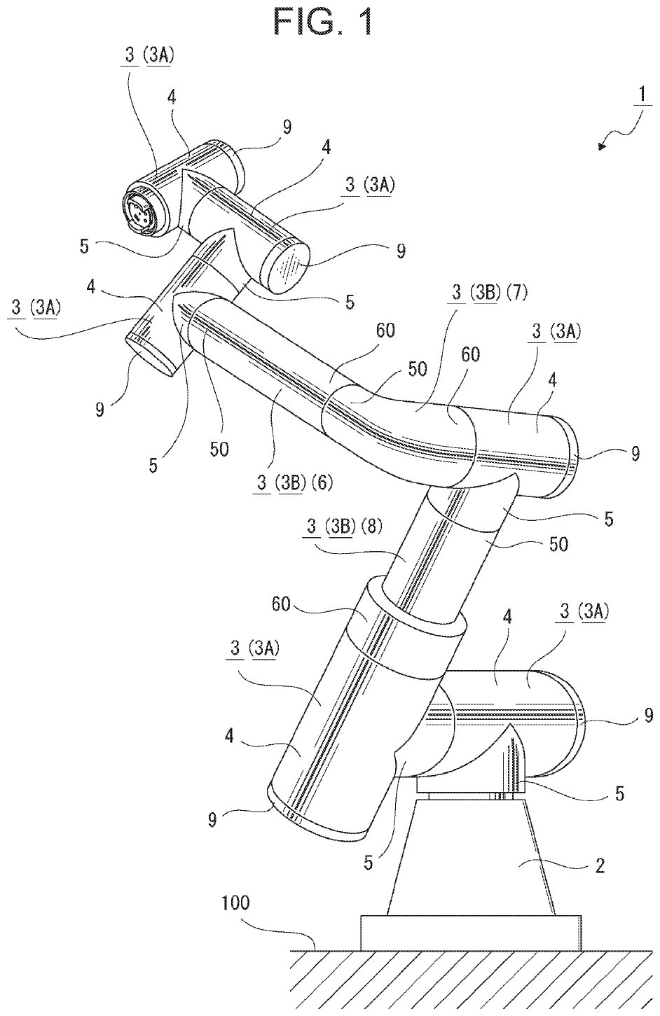

First, a schematic structure of a robot device 1 will be described (see FIG. 1). The robot device 1 has e.g. a function of transferring an object such as a box and/or goods, and is used e.g. for an application of packaging goods.

The robot device 1 includes a base 2 to be put on a floor 100 or other, and assemblies for a robot 3, 3, . . . , which are coupled in a successive manner, wherein an assembly 3 which is located at a lower end is rotatably coupled to the base 2. For example, an arm hand which is not shown is coupled to an assembly 3 located on at an upper end, wherein an object to be transferred is gripped and transferred to a predetermined position by the arm hand.

As the assemblies 3, a joint for a robot 3A or an arm for a robot 3B is used.

The joint 3A has a base section 4 and a protrusion 5, wherein the base section 4 has an outer substantially cylindrical shape, and the protrusion 5 protrudes from a middle portion of the base section 4 in its axial direction in a direction orthogonal to the axial direction of the base section 4.

As the arms 3B, e.g. an arm with constant diameter 6, an elbow with varying diameter 7, and an arm with varying diameter 8 are used, wherein the arm with constant diameter 6 is formed in a substantially cylindrical shape with a constant diameter, the elbow with varying diameter 7 has a diameter varying along its axial direction and a bent shape, and a portion of the arm with varying diameter 8 has a different diameter than another portion thereof.

Here, caps 9 are attached to ends of the assemblies 3 which are not coupled to other assemblies 3 or the base 2, wherein the caps 9 close portions of the assemblies 3 which are not coupled to other assemblies 3 or the base 2.

For the robot device 1, e.g. the elbow with varying diameter 7 and/or the arm with varying diameter 8 enable that in the assemblies 3, 3, . . . coupled in a successive manner as described above, the joint 3A (upper joint) on a tip side has a smaller size than the joint 3A (lower joint) on a base end side. Accordingly, the elbow with varying diameter 7 and/or the arm with varying diameter 8 may enable the robot device 1 to be reduced in its size and weight while increasing an operation velocity due to the reduction in the weight.

<Structure of an Assembly for a Robot>

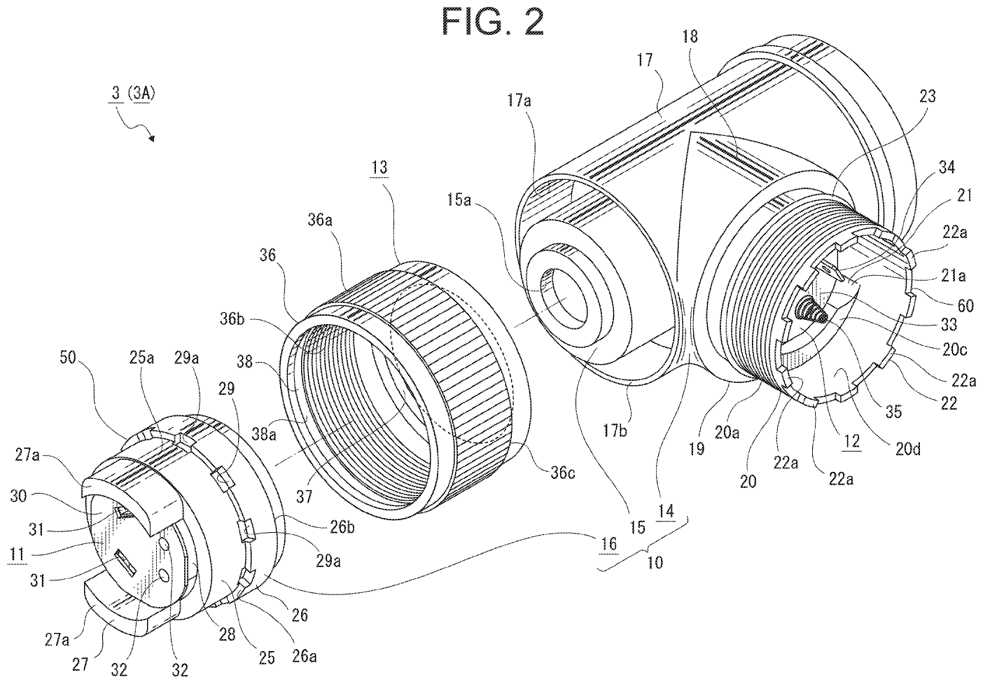

Hereinafter, a detailed structure of the assembly for a robot 3 will be described (see FIGS. 2 to 7). In the following, a structure of a joint for a robot 3A will be described by way of example.

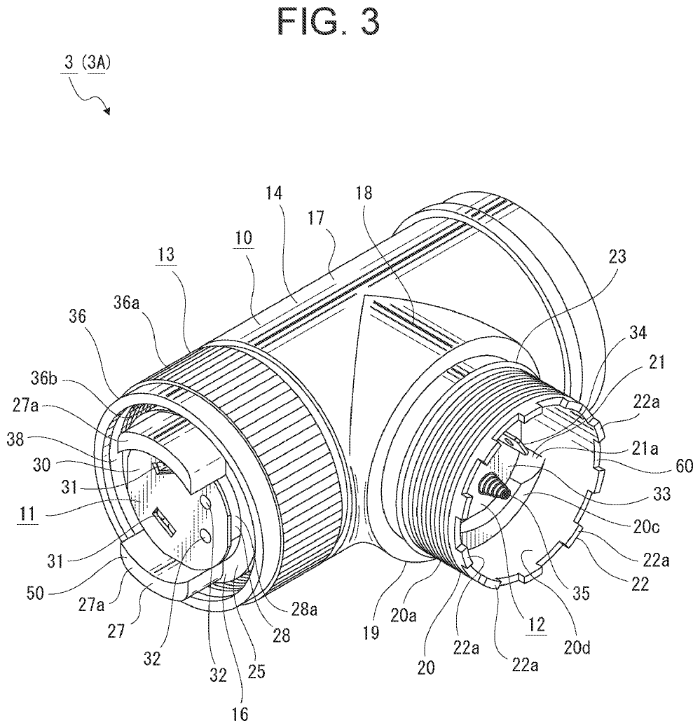

The assembly 3 (joint 3A) includes a main body 10, a first circuit board 11, a second circuit board 12, and a fastening ring 13 (see FIGS. 2 and 3).

The main body 10 includes a casing 14, a fixing protrusion 15 and a fixed section 16, wherein an actuator which is not shown is arranged within the casing 14, the fixing protrusion 15 is coupled to the actuator, and the fixed section 16 is configured to be fixed to the fixing protrusion 15.

The casing 14 includes a cylindrical base tube section 17 and a protruding tube section 18 which protrudes from a middle portion of the base tube section 17 in its axial direction.

The base tube section 17 forms a part of the above-mentioned base section 4, while the protruding tube section 18 forms a part of the above-mentioned protrusion 5. Accordingly, a cap 9 is attached to one end of the base tube section 17 in its axial direction. The base tube section 17 has an opening 17a on a side to which no cap 9 is attached.

The fixed section 16 is configured to be fixed to an end of the base tube section 17 to which no cap 9 is attached, wherein the fixed section 16 is configured as a first coupling section 50 in a male form for coupling to another assembly for a robot 3. For the protruding tube section 18, a portion thereof on its tip side is configured as a second coupling section 60 in a female form for coupling to another assembly for a robot 3.

The protruding tube section 18 protrudes in a direction orthogonal to the axial direction of the base tube section 17, wherein the axial direction of the base tube section 17 is orthogonal to an axial direction of the protruding tube section 18. The protruding tube section 18 is formed in a substantially cylindrical shape, and includes a large-diameter section 19 and a small-diameter section 20 having a smaller diameter than the large-diameter section 19, wherein the large-diameter section 19 is continuous with the base tube section 17 and the small-diameter section 20 is continuous with a tip section of the large-diameter section 19.

A first positioning section 21 is formed inside the small-diameter section 20, wherein the first positioning section 21 is constituted with two first alignment elements 21a, 21a which are formed spaced in a direction of rotation around an axis (see FIGS. 2 to 4). The first alignment elements 21a, 21a are substantially 180 degrees opposite to each other in the direction of rotation around the axis. The first alignment elements 21a, 21a are configured as recesses which are open toward a tip of the small-diameter section 20 and toward a center of the small-diameter section 20. Accordingly, on an inner side of the small-diameter section 20, arc-shaped overhangs 20c, 20c are formed spaced in a circumferential direction between the first alignment elements 21a, 21a, the overhangs 20c, 20c overhanging inwardly.

An inner circumferential surface of the small-diameter section 20 is configured as a coaxial guiding surface 20d. The coaxial guiding surface 20d is formed in a cylindrical surface.

The first alignment elements 21a, 21a are formed inside the small-diameter section 20 at an end facing the large-diameter section 19, with different widths in the circumferential direction. Accordingly, one of the first alignment elements 21a has a larger width in the circumferential direction than the other of the first alignment elements 21a.

The small-diameter section 20 includes a threaded section 20a formed in its outer circumferential surface (see FIGS. 2 and 3). The small-diameter section 20 includes second positioning section 22 at the tip section. The second positioning section 22 is constituted with many second alignment elements 22a, 22a, . . . , i.e. at least three or more second alignment elements 22a, 22a, . . . which are spaced in the direction of rotation around the axis. The second alignment elements 22a, 22a, . . . are spaced equidistantly in the direction of rotation around the axis, and configured as convex sections protruding in the axial direction of the small-diameter section 20.

The small-diameter section 20 includes a holding groove 20b on its outer circumferential surface, wherein the holding groove 20b is located opposite to the second positioning section 22 with regard to the threaded section 20a (see FIG. 5). An O-ring 23 is held by the holding groove 20b, the O-ring 23 being formed with an elastically deformable material, such as a lubber material. The O-ring 23 partially protrudes out of the holding groove 20b.

The fixing protrusion 15 has a shape which extends in the axial direction of the base tube section 17, wherein the fixing protrusion 15 partially protrudes from the opening 17a of the base tube section 17 (see FIG. 2). The fixing protrusion 15 has a cable insertion hole 15a through which e.g. a power supply cable and/or a signal cable which are not shown may be inserted.

The fixed section 16 is attached to a tip portion of the fixing protrusion 15 e.g. via screwing, wherein the fixed section 16 then covers the cable insertion hole 15a, the fixed section 16 being located on an outer side of the base tube section 17 in the axial direction (see FIGS. 2, 3 and 6).

The fixed section 16 includes a base face section 24 having an annular shape, a cylindrical middle section 25, a substantially cylindrical section with a recess(es) 26, and a first positioning section 27, wherein the middle section 25 protrudes from an outer circumference of the base face section 24, the section with recesses 26 protrudes from the outer circumference of the base face section 24 away from the middle section 25, and the first positioning section 27 protrudes from the middle section 25 away from the base face section 24. The fixed section 16 has an axial direction coinciding with the axial direction of the base tube section 17.

On the base face section 24, a board mounting member 28 is attached to a surface facing the first positioning section 27. The board mounting member 28 includes an annular base portion 28a and mounting protrusions 28b, 28b, . . . , wherein the mounting protrusions 28b, 28b, . . . protrude from the base portion 28a away from the base face section 24.

An outer circumferential surface of the middle section 25 is configured as a coaxial guiding surface 25a. The coaxial guiding surface 25a is configured as a cylindrical surface, and has a diameter which is substantially same as or slightly smaller than that of the coaxial guiding surface 20d of the small-diameter section 20.

The section with recesses 26 has a larger diameter than the middle section 25, wherein a face of the section with recesses 26 which is oriented toward the middle section 25 is configured as a step surface 26a. A second positioning section 29 is formed in the section with recesses 26. The second positioning section 29 is formed in the step surface 26a and constituted with many second alignment elements 29a, 29a, . . . , i.e. at least three or more second alignment elements 29a, 29a, . . . which are spaced in the direction of rotation around the axis. The second alignment elements 29a, 29a, . . . are spaced equidistantly in the direction of rotation around the axis, and configured as recesses which are open toward one end of the fixed section 16 in the axial direction as well as outward in a radial direction of the fixed section 16.

In section with recesses 26, a limiting surface 26b in a step shape is formed in a middle portion in the axial direction, the limiting surface 26a facing away from the step surface 26a.

The first positioning section 27 is constituted with two first alignment elements 27a, 27a which are spaced in the direction of rotation around the axis. The first alignment elements 27a, 27a are substantially 180 degrees opposite to each other in the direction of rotation around the axis. The first alignment elements 27a, 27a are configured as convex sections which are formed in an arc shape around a center of the base face section 24. The first alignment elements 27a, 27a are formed with different widths in the circumferential direction. Accordingly, one of the first alignment elements 27a has a larger width in the circumferential direction than the other of the first alignment elements 27a.

The first circuit board 11 is mounted to mounting protrusions 28b, 28b, . . . of the board mounting member 28, and spaced from the base face section 24 and the base portion 28a in the axial direction of the fixed section 16. The first circuit board 11 includes a first base board 30, terminals for power supply 31, 31, and terminals for signal 32, 32. The terminals for power supply 31, 31 and the terminals for signal 32, 32 share a common ground.

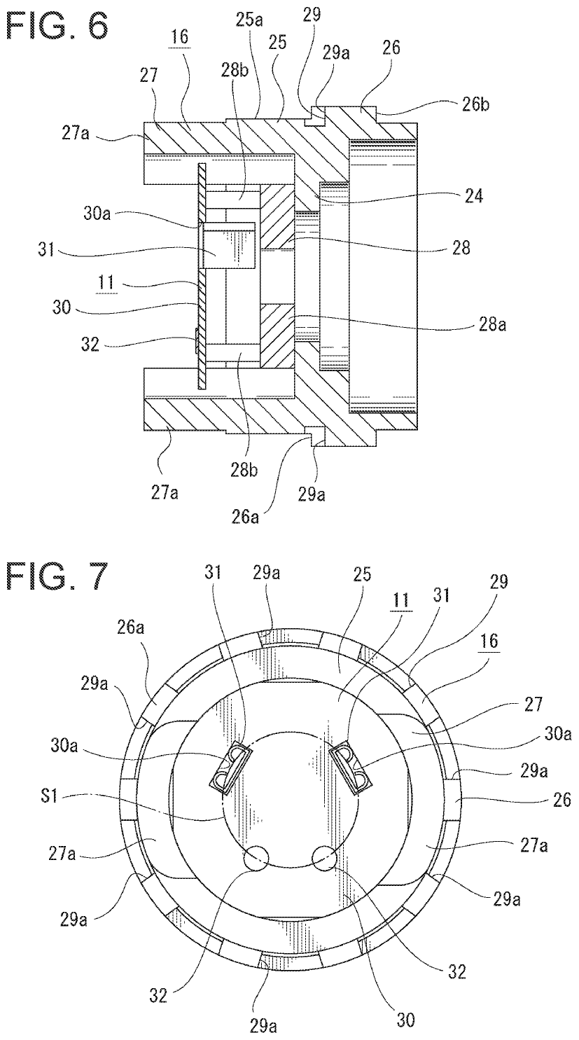

The first base board 30 is formed in a substantially circular disc, and is located between the first alignment elements 27a, 27a (see FIGS. 6 and 7). In the first base board 30, terminal insertion holes 30a, 30a are formed spaced in a circumferential direction around a center. Each of the terminals for power supply 31, 31 is mounted in face of the first base board 30 opposed to the base portion 28a to a position with a terminal insertion hole 30a, 30a formed therein. The terminals for signal 32, 32 are each positioned spaced in the circumferential direction around the center of the first base board 30, extending through the first base board 30 in its thickness direction.

The terminals for power supply 31, 31 and the terminals for signal 32, 32 are positioned on the substantially same circle S1 in the circumferential direction around the center of the first base board 30, wherein the terminals for power supply 31, 31 and the terminals for signal 32, 32 are successively positioned spaced in the circumferential direction (see FIG. 7).

One end of the above-mentioned power supply cable is connected to each of the terminals for power supply 31, 31, wherein one end of the above-mentioned signal cable is connected to each of the terminals for signal 32, 32. The power supply cable and the signal cable are inserted through each of the board mounting member 28, the middle section 25, the base face section 24 and the section with recesses 26, then extending through the cable insertion hole 15a in the fixing protrusion 15 toward the inside of the main body 10.

The second circuit board 12 is arranged within the small-diameter section 20 of the protruding tube section 18, and positioned inside the second alignment elements 22a, 22a (see FIGS. 2 to 4). The second circuit board 12 includes a second base board 33, power supply terminal sections 34, 34 and signal terminal sections 35, 35. The power supply terminal sections 34, 34 and the signal terminal sections 35, 35 share a common ground.

The power supply terminal sections 34 are terminal sections to be connected to the terminals for power supply 31. They may be interchanged, i.e. the power supply terminal sections 34 may be terminals for power supply, wherein the terminals for power supply 31 may be power supply terminal sections. Further, the signal terminal sections 35 are terminal sections to be connected to the terminals for signal 32. They may be interchanged, i.e., the signal terminal sections 35 may be terminals for signal, wherein the terminals for signal 32 may be signal terminal sections.

The second base board 33 is formed in a substantially circular disc. The power supply terminal sections 34, 34 each protrude from the second base board 33 away from the large-diameter section 19. The signal terminal sections 35, 35 each protrude from the second base board 33 away from the large-diameter section 19, and are formed in a coil spring shape.

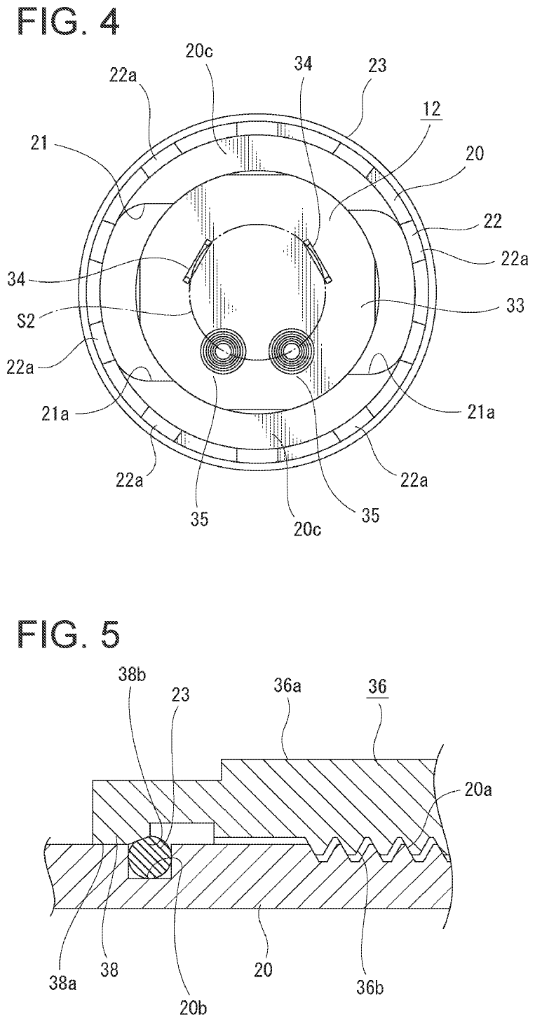

The power supply terminal sections 34, 34 and the signal terminal sections 35, 35 are positioned on the substantially same circle S2 in a circumferential direction around a center of the second base board 33, wherein the power supply terminal sections 34, 34 and the signal terminal sections 35, 35 are successively positioned spaced in the circumferential direction (see FIG. 4).

The other end of the power supply cable is connected to each of the power supply terminal sections 34, 34, wherein the other end of the signal cable is connected to each of the signal terminal sections 35, 35.

It is to be noted that the power supply cables and the signal cables may be connected to a driving circuit for the actuator and/or an intermediate board which are arranged inside the main body 10 and not shown, wherein the cables may be connected between the terminals for power supply 31 and the power supply terminal sections 34 or between the terminals for signal 32 and the signal terminal sections 35 via the driving circuit and/or intermediate board.

The fastening ring 13 is rotatably supported by the main body 10 (see FIGS. 2 and 3). The fastening ring 13 is formed from a cylindrical fastening section 36 and an anti-removal section 37, wherein the anti-removal section 37 overhangs inwardly from one end of the fastening section 36 in an axial direction of the fastening section 36.

On an outer circumferential surface, the fastening section 36 includes an anti-slip section 36a which is e.g. knurled, wherein the fastening section 36 has thread grooves 36b in an inner circumferential surface (see FIGS. 2 and 5). The fastening section 36 has no thread grooves 36b at the other end in the axial direction, wherein a section to be acted on 38 is provided at the other end, the section to be acted on 38 overhanging inwardly. The section to be acted on 38 includes a flat surface 38a and a pressed surface 38b, wherein the flat surface 38a is oriented in a direction of a center axis of the fastening section 36, and the pressed surface 38b is continuous with an end edge of the flat surface 38a facing the thread grooves 36b. The flat surface 38a is formed closer to the outer circumferential surface of the fastening section 36 in a radial direction of the fastening section 36 than to end edges of the thread grooves 36b on an inner circumference side. The pressed surface 38b is inclined in a direction approaching the outer circumferential surface of the fastening section 36 toward the thread grooves 36b.

A portion of the fastening section 36 in which the thread grooves 36b are formed has an outer diameter which is some larger than that of the remainder, wherein a step surface of the portion with the thread grooves 36b formed therein is configured as a receiving surface 36c, the step surface being located facing the anti-removal section 37 in the axial direction.

For the fastening ring 13, the fastening section 36 has a larger inner diameter than an outer diameter of the section with recesses 26 of the fixed section 16, wherein the section to be acted on 38 has a smaller inner diameter than an outer diameter of the section with recesses 26.

The fastening ring 13 is provided so that the fixing protrusion 15 is inserted into an end of the fastening ring 13 on a side of the section to be acted on 38 in the axial direction, wherein the fastening ring 13 is rotatably supported on the main body 10 by fixing the fixed section 16 to the fixing protrusion 15 e.g. via screwing while the fixed section 16 is inserted into the fastening section 36. In a supported state by the main body 10, the fastening ring 13 is movable in one direction along the axial direction to a position where the receiving surface 36c comes into contact with an end face 17b of the base tube section 17, wherein the fastening ring 13 is further movable in the other direction along the axial direction to a position where the section to be acted on 38 comes into contact with the limiting surface 26b of the section with recesses 26. Accordingly, removal of the fastening ring 13 from the main body 10 is prevented by the section to be acted on 38 being in contact with the limiting surface 26b.

In the supported state by the main body 10, the fastening ring 13 is rotated relative to the main body 10. During this, the fastening ring 13 may be rotated while a user is gripping the anti-slip section 36a, so that the fastening ring 13 can be rotated reliably without his/her fingers slipping from the fastening ring 13.

Although in the above description, the structure of the joint 3A has been described by way of example for understanding the structure of the assembly 3 for a robot, the arm for a robot 3B has a similar structure to that of the joint 3A, wherein one end of the arm 3B in its axial direction is configured as the first coupling section 50 in the male form for coupling to another assembly 3, and the other end of the arm 3B in the axial direction is configured as the second coupling section 60 in the female form for coupling to another assembly 3 (see FIG. 1).

<Coupling Operation of the Assemblies for a Robot>

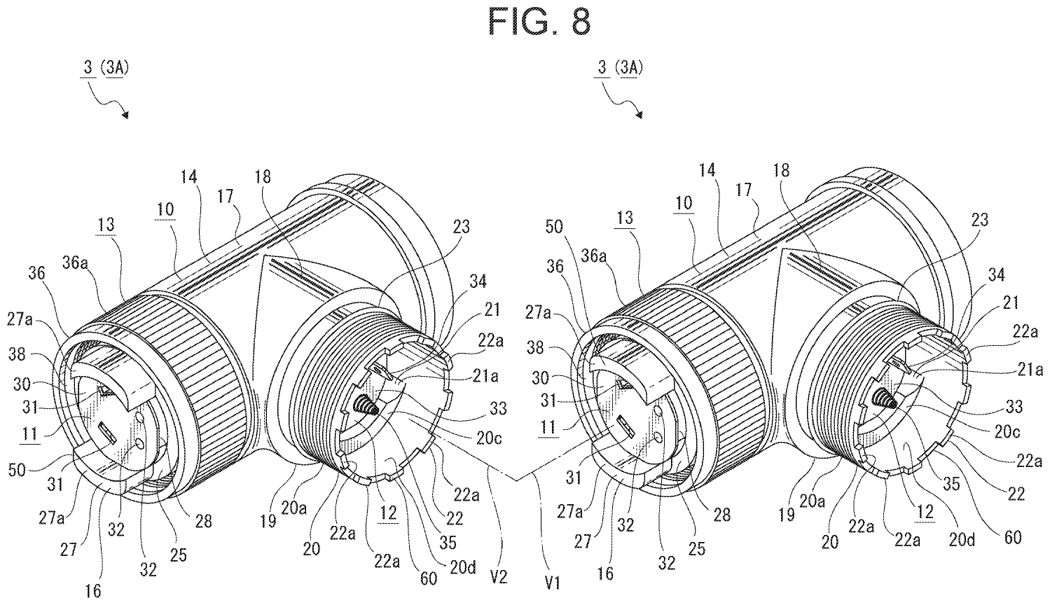

Hereinafter, a coupling operation for coupling the assembly 3 to another assembly 3 will be described (see FIGS. 8 to 13).

For the robot device 1, the first coupling section 50 of the assembly 3 and the second coupling section 60 of the other assembly 3 are coupled to each other for example, wherein the first coupling section 50 is coupled to the second coupling section 60 in an axial direction V1, and the second coupling section 60 is also coupled to the first coupling section 50 in an axial direction V2 (see FIG. 8). Accordingly, coupling directions of the assemblies 3, 3 coincide with their axial directions. For the robot device 1, it is to be noted that the second coupling section 60 of the assembly 3 may be coupled to the first coupling section 50 of the other assembly 3.

For the assembly 3 and the other assembly 3, the first male coupling section 50 is coupled to the second female coupling section 60, wherein the assembly 3 and the other assembly 3 to be coupled may be joints for a robot 3A and/or arms for a robot 3B. Accordingly, a joint 3A is coupled to another joint 3A or an arm 3B, and an arm 3B is coupled to a joint 3A or another arm 3B.

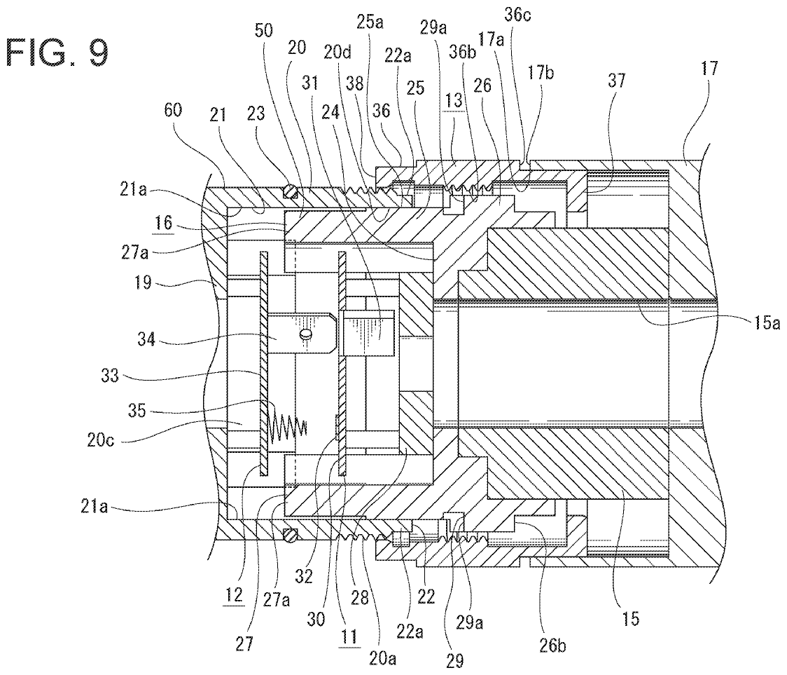

For coupling the assembly 3 to the other assembly 3, the first alignment elements 27a, 27a of the first positioning section 27 of the first male coupling section 50 are first inserted into the respective first alignment elements 21a, 21a of the first positioning section 21 of the second female coupling section 60 (see FIG. 9). Here, one of the first alignment elements 27a has a larger width in the circumferential direction than the other of the first alignment elements 27a, wherein one of the first alignment elements 21a has a larger width in the circumferential direction than the other of the first alignment elements 21a.

Thus, the one of the first alignment elements 27a with a larger width may not be inserted into the other of the first alignment elements 21a with a smaller width, wherein positioning in the direction of rotation around the axis is accomplished for the assembly 3 and the other assembly 3 by inserting the one of the first alignment elements 27a into the other of the first alignment elements 21a and by inserting the other of the first alignment elements 27a into the other of the first alignment elements 21a.

For inserting the first alignment elements 27a, 27a of the first positioning section 27 into the respective first alignment elements 21a, 21a of the first positioning section 21, the middle section 25 is first inserted into the small-diameter section 20 (see FIG. 9). Here, since the coaxial guiding surface 25a of the middle section 25 has substantially the same diameter or a slightly smaller diameter than the coaxial guiding surface 20d of the small-diameter section 20, the middle section 25 and the small-diameter section 20 are positioned in a radial direction, and an axis (center axis) of the first coupling section 50 coincides with the axis (center axis) of the second coupling section 60.

Immediately after inserting the first alignment elements 27a, 27a into the respective first alignment elements 21a, 21a, the terminals for power supply 31, 31 and the terminals for signal 32, 32 are not connected to the power supply terminal sections 34, 34 and the signal terminal sections 35, 35 yet. At this time, the fastening ring 13 is further in a state where the thread grooves 36b are spaced from the threaded section 20 of the threaded section 20a of the small-diameter section 20.

It is to be noted that in the case of positioning the assembly 3 and the other assembly 3 in the direction of rotation around the axis with two first alignment elements 27a and two first alignment elements 21a for each of the assemblies 3, a small number of first alignment elements 27a and first alignment elements 27a may result in a slight gap between the first alignment elements 27a and 21a in the direction of rotation around the axis depending on their processing accuracy, which may not ensure a sufficient positioning accuracy.

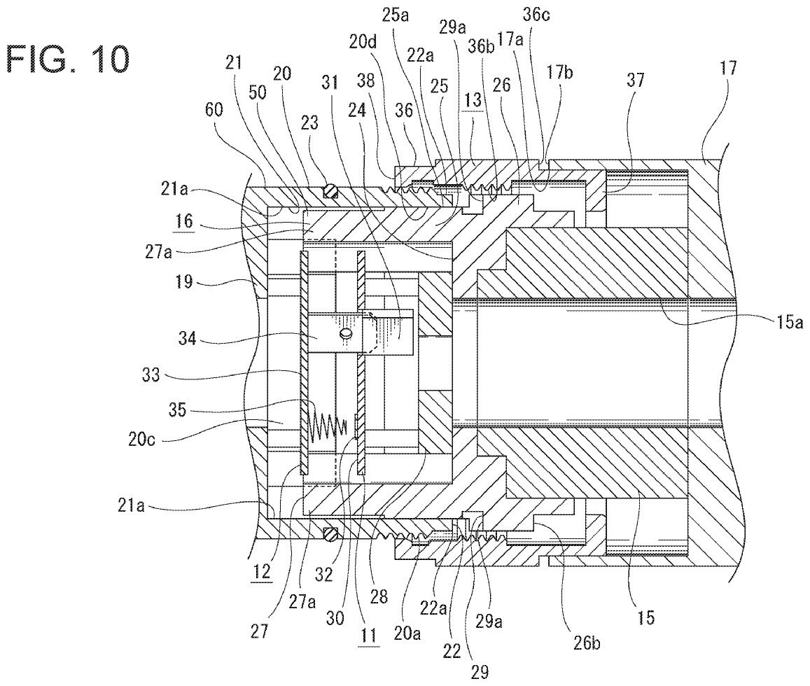

By further inserting the first alignment elements 27a, 27a into the first alignment elements 21a, 21a, the power supply terminal sections 34, 34 are first inserted into the respective terminal insertion holes 30a, 30a in the first base board 30 of the first circuit board 11, and the terminals for power supply 31, 31 are connected to the respective power supply terminal sections 34, 34 (see FIG. 10). At this time, the terminals for signal 32, 32 are spaced from the respective signal terminal sections 35, 35, and thus, the terminals for signal 32, 32 are not connected to the signal terminal sections 35, 35.

At this time, connection of the terminals for power supply 31, 31 to the power supply terminal sections 34, 34 result in a stabilized connection to the ground.

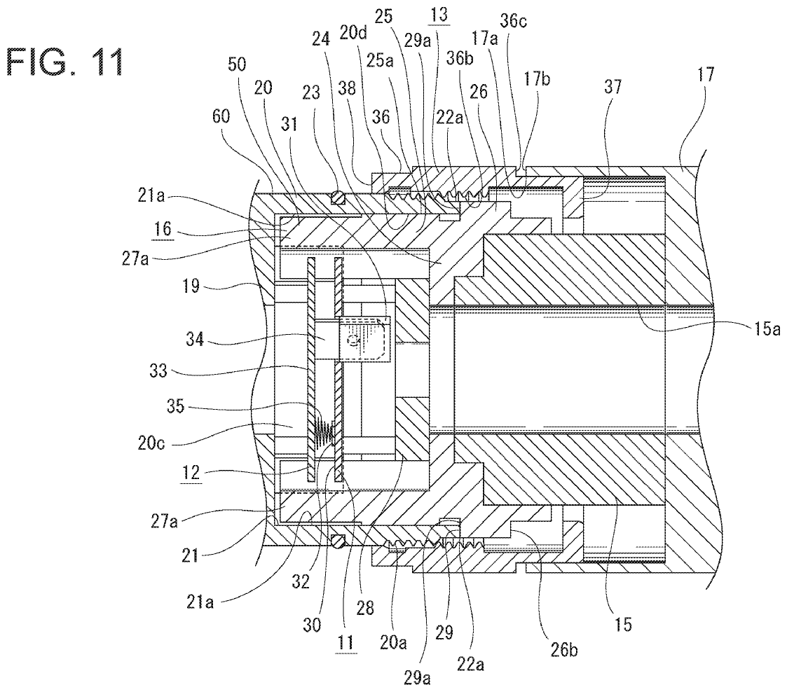

By further inserting the first alignment elements 27a, 27a into the respective first alignment elements 21a, 21a in the state where the terminals for power supply 31, 31 are connected to the respective power supply terminal sections 34, 34, the second alignment elements 22a, 22a, . . . of the second positioning section 22 of the second female coupling section 60 are inserted into the respective second alignment elements 29a, 29a, . . . of the second positioning section 29 of the first male coupling section 50 (see FIG. 11).

At this time, by inserting many second alignment elements 22a, 22a, . . . into many second alignment elements 29a, 29a, . . . , it is difficult to cause a gap between one or more of the second alignment elements 22a and one or more of the second alignment elements 29a, which makes it difficult to cause looseness therebetween, so that a high positioning accuracy in the direction of rotation around the axis is ensured for the assembly 3 and the other assembly 3.

Further, by inserting the second alignment elements 22a, 22a, . . . into the second alignment elements 29a, 29a, . . . , the small-diameter section 20 are in contact with the section with recesses 26 in the axial direction, wherein the assembly 3 and the other assembly 3 are positioned in the axial direction.

For the assemblies 3, 3, positioning in the direction of rotation around the axis is accomplished at least with the first positioning sections 27, 21, and positioning in both the axial direction and the direction of rotation around the axis is accomplished with the second positioning sections 29, 22, as described above.

Accordingly, positioning for the assemblies 3 is performed with different positioning sections for the direction of rotation around the axis and the axial direction individually, which enables positioning in each of the different directions to be performed with high accuracy.

Further, positioning in both the axial direction and the direction of rotation around the axis is performed with the second positioning sections 29, 22 in the state where positioning in the direction of rotation around the axis has been performed with the first positioning sections 27, 21.

Accordingly, positioning in the direction of rotation around the axis is performed by means of the first positioning sections 27, 21 each having two first alignment elements 27a, 21a and by means of the second positioning section 29, 22 each having three or more alignment elements 29a, 22a in a successive manner, which facilitates the coupling operation and enables the assemblies 3 to be positioned in the direction of rotation around the axis with high accuracy.

Once the second alignment elements 22a, 22a, . . . have been inserted into the second alignment elements 29a, 29a, . . . , the terminals for signal 32, 32 are connected to the signal terminal sections 35, 35 while connection of the terminals for power supply 31, 31 to the power supply terminal sections 34, 34 is maintained. Due to the signal terminal sections 35, 35 being configured in a coil-spring shape, the signal terminal sections 35, 35 are then pressed against the terminals for signal 32, 32 in an elastically deformed state, so that the terminals for signal 32, 32 are connected to the signal terminal sections 35, 35.

Accordingly, the signal terminal sections 35, 35 are connected to the respective terminals for signal 32, 32 via a biasing force, while being pressed against the terminals for signal 32, 32, so that for example even in the case of vibration etc. during operation of the robot device 1, the signal terminal sections 35, 35 remain pressed against the terminals for signal 32, 32, which can ensure a stable connection of the terminals for signal 32, 32 to the signal terminal sections 35, 35.

Further, for the robot device 1, positioning is performed with the second positioning sections 29, 22 in the state where positioning has been performed with the first positioning sections 27, 21 as described above, and when coupling the first coupling section 50 to the second coupling section 60, connection of the terminals for signal 32 to the signal terminal sections 35 is performed in the state where the connection of the terminals for power supply 31 to the power supply terminal sections 34 has been performed.

Accordingly, since the connection of the terminals for signal 32 to the signal terminal sections 35 is performed after the connection of the terminals for power supply 31 to the power supply terminal sections 34, connection of the terminals for signal 32 to the power supply terminal sections 34 is performed in a stabilized state of the connection to the ground, which may enable a signal communication state to be stabilized.

Furthermore, the terminals for power supply 31 are connected to the power supply terminal sections 34 with high voltage and high current, the terminals for signal 32 are connected to the signal terminal sections 35 with low voltage and low current, a common ground is used for the terminals for power supply 31 and the terminals for signal 32, and the connection of the terminals for power supply 31 is performed before the connection of the terminals for signal 32. In this manner, the connection of the terminals for signal 32 is performed with the connection to the ground being stabilized even in the case where the coupling operation of the assemblies 3, 3 when power is supplied, which may enable the safety with regard to the electric connection to be increased.

As described above, for coupling the assembly 3 to the other assembly 3, the first positioning section 27 is inserted into the first positioning section 21, and the terminals for power supply 31 is connected to the power supply terminal sections 34, wherein the terminals for signal 32 are connected to the signal terminal sections 35. Thus, the first positioning section 27 and the first positioning section 21 function as coaxial guiding sections for the first coupling section 50 and the second coupling section 60, and simultaneously have a function of prescribing the polarities so as to connect positive poles of the terminals for power supply 31 to each other and ground poles thereof to each other, as well as to connect signal 1 sides of the terminals for signal 32 to each other and signal 2 sides thereof to each other.

Furthermore, the second positioning section 22 is inserted into the second positioning section 29, and the terminals for power supply 31 are connected to the power supply terminal sections 34, wherein the terminals for signal 32 are connected to the signal terminal sections 35. Accordingly, the second positioning section 22 and the second positioning section 29 have a function of ensuring the position accuracy for the first coupling section 50 and the second coupling section 60 in the direction of rotation around the axis, and simultaneously have a function of defining a connection length for the terminals for power supply 31 and the power supply terminal sections 34 in the axial direction as well as a connection length for the terminals for signal 32 and the signal terminal sections 35 in the axial direction.

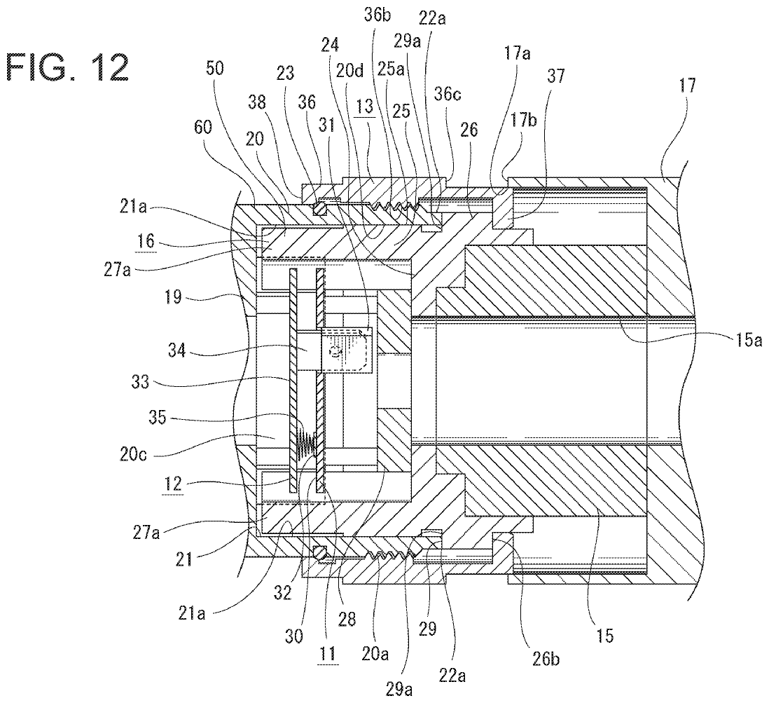

In the state where positioning in the axial direction and the direction of rotation around the axis has been performed with the first positioning section 27, 21 and the second positioning section 29, 22 as described above, the fastening ring 13 is moved in the axial direction relative to the main body 10 and rotated in one direction (see FIG. 12).

Once the fastening ring 13 has been rotated in the one direction, the thread grooves 36b in the fastening section 36 are screwed onto the threaded section 20a in the small-diameter section 20. The fastening ring 13 is rotated to a position in which the anti-removal section 37 is pressed against the limiting surface 26b in the section with recesses 26. In this manner, the first coupling section 50 and the second coupling section 60 are fixed to each other by the fastening ring 13, wherein the assembly 3 is coupled and fixed to the other assembly 3.

By the above-described rotation of the fastening ring 13 in the one direction in the coupled state of the first coupling section 50 to the second coupling section 60 as described above, the thread grooves 36b are screwed onto the threaded section 20a of the other assembly 3.

Thus, the first coupling section 50 is fixed to the second coupling section 60 by rotating the fastening ring 13 relative to the main body 10 in the state where the fixed section 16 has been positioned, so that a stable coupled state can be ensured between the first coupling section 50 and the second coupling section 60.

In the state where the first coupling section 50 and the second coupling section 60 are fixed to each other by the fastening ring 13 as described above, the pressed surface 38b in the section to be acted on 38 of the fastening ring 13 is pressed against the O-ring 23 held in the holding groove 20b in the small-diameter section 20 to elastically deform the O-ring 23 (see FIG. 5).

Thus, a biasing force is applied to the fastening ring 13 by the O-ring 23, the biasing force acting in a direction away from the main body 10 in the axial direction, wherein the thread ridges of the male thread and the female threads are fitted to each other between the thread grooves 36b and the threaded section 20a. This prevents the looseness of the fastening ring 13 with regard to the small-diameter section 20, which may ensure the stable fixed state between the first coupling section 50 and the second coupling section 60.

It is to be noted that in the state where the pressed surface 38b of the fastening ring 13 is pressed against the O-ring 23, a gap between the fastening ring 13 and the small-diameter section 20 is sealed by the O-ring 23, so that it is possible to prevent dusts from entering through the gap.

On the other hand, the fixed state between the first coupling section 50 and the second coupling section 60 is released by rotating the fastening ring 13 relative to the main body 10 in the other opposite direction.

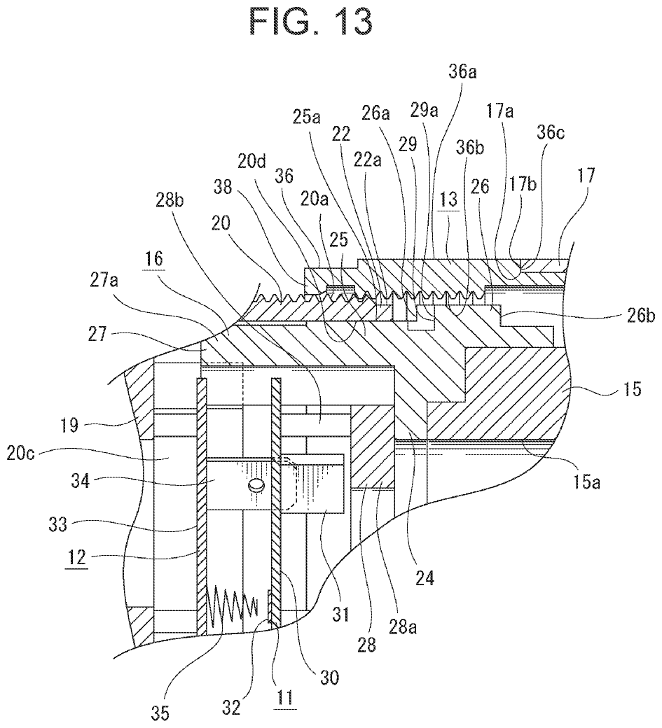

When the fastening ring 13 has been rotated to a predetermined position, the receiving surface 36c comes into contact with the end face 17b of the base tube section 17, so that movement of the fastening ring 13 toward the base tube section 17 is limited (see FIG. 13). It may be also configured so that the first alignment elements 27a, 27a of the first positioning section 27 have been inserted into the respective first alignment elements 21a, 21a of the first positioning section 21 at this time, wherein the other assembly 3 is brought in a non-rotatable state in the direction of rotation around the axis, and furthermore, the thread grooves 36b are not disengaged from the threaded section 20a even in the case where the fastening ring 13 is rotated in the opposite direction.

With such a configuration, the second coupling section 60 of the other assembly 3 is separated from the first coupling section 50 in the axial direction as the fastening ring 13 is rotated, so that the terminals for signal 32, 32 are disconnected from the signal terminal sections 35, 35 while the terminals for power supply 31, 31 remain connected to the power supply terminal sections 34, 34. By further rotating the fastening ring 13, the terminals for power supply 31, 31 are disconnected from the power supply terminal sections 34, 34, and the first coupling section 50 and the second coupling section 60 are then decoupled.

With such rotation of the fastening ring 13 in the opposite direction which is accompanied by separation of the assembly 3 relative to the other assembly 3, the terminals for power supply 31 and the terminals for signal 32 are disconnected from the terminal sections with the rotation of the fastening ring 13, whereby the fixed state between the first coupling section 50 and the second coupling section 60 is released together with the disconnection of the terminals for power supply 31 and the terminals for signal 32 from the terminal sections by one operation. In this manner, the increase in the operability may be enabled.

As described above, for the assemblies for a robot 3, it is possible to couple the first coupling section 50 to the second coupling section 60 in the state where they have been positioned, wherein when coupling the first coupling section 50 to the second coupling section 60, the terminals for power supply 31 and the terminals for signal 32 are connected to the power supply terminal sections 34 and the signal terminal sections 35 of the other assembly 3, respectively.

Accordingly, in the positioned state, coupling the first coupling section 50 to the second coupling section 60 is performed and the terminals for power supply 31 and the terminals for signal 32 are connected to the power supply terminal sections 34 and the signal terminal sections 35, which may ensure a mechanically and electrically correct coupled state and additionally enable the operability for coupling the assembly 3 to the other assembly 3 to be improved.

Particularly e.g. when the robot device 1 requires maintenance and/or a fault has occurred in the robot device 1, it is possible to ensure the mechanically and electrically coupled state by a simple operation without soldering and/or wiring etc. Therefore, e.g. the coupling operation can be performed by a user of the robot device 1 by himself/herself without requesting a specialized service provider, so that it is possible to enable the productivity to be increased due to reduction in the downtime.

Further, for the assemblies for a robot 3, it is possible to couple the first coupling section 50 to the second coupling section 60 in the state where they have been positioned, wherein when coupling the first coupling section 50 to the second coupling section 60, the terminals for power supply 31 and the terminals for signal 32 are connected to the power supply terminal sections 34 and the signal terminal sections 35 of the other assembly 3, respectively.

Accordingly, in the positioned state, coupling the first coupling section 50 to the second coupling section 60 is performed and the terminals for power supply 31 and the terminals for signal 32 are connected to the power supply terminal sections 34 and the signal terminal sections 35, which may ensure an electrically correct connection state and additionally enable the operability for coupling the assembly 3 to the other assembly 3 to be improved.

Furthermore, each of the first coupling section 50 and the second coupling section 60 has the coaxial guiding surface 25a, 20d formed therein for causing the axes to coincide with those of the first coupling section 50 and the second coupling section 60 of the other assembly 3.

In this manner, the axes coincide with each other by means of the coaxial guiding surfaces 25a, 20d when coupling the first coupling section 50 and the second coupling section 60 to the second coupling section 60 or the first coupling section 50 of the other assembly 3, which may ensure a high positioning accuracy between the first coupling section 50 or the second coupling section 60 and the second coupling section 60 or the first coupling section 50 of the other assembly 3 in the radial direction.

Further, the assembly 3 includes the first coupling section 50 and the second coupling section 60.

Accordingly, it is possible to couple the first coupling section 50 and the second coupling section 60 to other assembly 3 in a successive manner, which enables a plurality of main bodies 10 to be linked in series to form a robot device 1 having a desired structure.

Furthermore, for the joint for a robot 3A, the coupling direction of the first coupling section 50 is orthogonal to the coupling direction of the second coupling section 60.

This enables the first coupling section 50 and the second coupling section 60 to be coupled to the other assembly 3 in directions orthogonal to each other, which may enable degrees of freedom for the structure of the robot device 1 to be improved.

On the other hand, for the arm for a robot 3B, the coupling direction of the first coupling section 50 is opposite to the coupling direction of the second coupling section 60.

This enables the first coupling section 50 and the second coupling section 60 to be coupled to the other assembly 3 in the opposite directions, which enables a length of the robot device 1 to be ensured and may enable the degrees of freedom for its structure to be improved.

Moreover, in the assemblies for a robot 3, the terminals for power supply 31, 31 are positioned on the substantially same circle S1 in the circumferential direction around the center of the first base board 30, so that when coupling the assemblies 3, the terminals for power supply 31, 31 are connected to the respective power supply terminal sections 34, 34 even in the case of some offset from the small-diameter section 20 in the circumferential direction, and it may be ensured that the terminals for power supply 31, 31 are connected to the power supply terminal sections 34, 34.

### REFERENCE SIGNS LIST

1 Robot device
3 Assemblies for a robot
10 Main body
11 First circuit board
12 Second circuit board
13 Fastening ring
21 First positioning section
21a First alignment elements
22 Second positioning section
22a Second alignment elements
27 First positioning section
27a First alignment elements
28 Board mounting member
29 Second positioning section
29a Second alignment elements
31 Terminals for power supply
32 Terminals for signal
34 Power supply terminal sections
35 Signal terminal sections
36b Thread grooves
50 First coupling section
60 Second coupling section

What is claimed is:

1. An assembly for a robot comprising:
a main body with a coupling section,
wherein the coupling section has a first positioning section and a second positioning section, and
wherein the assembly is configured so that in a state where positioning has been performed by the first positioning section, positioning by the second positioning section is performed and the coupling section is coupled to another coupling section of another main body.

2. The assembly according to claim 1,
wherein where a coupling direction of the coupling section is defined as an axial direction, the assembly is configured so that positioning in a direction of rotation around an axis is performed by the first positioning section, and
wherein positioning in both of the axial direction and the direction of rotation around the axis is performed by the second positioning section.

3. The assembly according to claim 2,
wherein the coupling section has a coaxial guiding surface which is configured for causing an axis to coincide with an axis of the another coupling section.

4. The assembly according to claim 1,
wherein the first positioning section comprises two first alignment elements which are spaced in the direction of rotation around the axis,
wherein the second positioning section comprises three or more second alignment elements which are spaced in the direction of rotation around the axis, and
wherein the assembly is configured so that in the state where positioning in the direction of rotation around the axis has been performed by the first positioning section, positioning in both of the axial direction and the direction of rotation around the axis is performed by the second positioning section.

5. The assembly according to claim 1, comprising a circuit board mounted to the coupling section,
wherein the circuit board includes a terminal for power supply and a terminal for signal, and
wherein when coupling the coupling section to the another coupling section, the terminal for power supply and the terminal for signal are configured to be connected to respective terminal sections on a circuit board mounted to the another coupling section.

6. The assembly according to claim 5,
wherein the terminal for power supply and the terminal for signal share a common ground, and
wherein when coupling the coupling section to the another coupling section, connection of the terminal for signal to a terminal section on the circuit board mounted to the another coupling section is performed in a state where the terminal for power supply has been connected to a terminal section.

7. The assembly according to claim 5,
wherein the main body includes a fastening ring rotatably supported thereon, the fastening ring having a thread groove, and
wherein in a state where the coupling section has been coupled to the another coupling section, the thread groove is configured to be screwed with the another coupling section by rotating the fastening ring in one direction.

8. The assembly according to claim 7,
wherein the assembly is configured so that the terminal for power supply and the terminal for signal are disconnected from the respective terminal sections by the coupling section being separated from the another coupling section which accompanies rotation of the fastening ring in another direction.

9. The assembly according to claim 1, comprising a first coupling section and a second coupling section as the coupling section,
wherein each of the first coupling section and a second coupling section is capable of coupling to another coupling section of the another assembly.

10. The assembly according to claim 9,
wherein a coupling direction of the first coupling section is orthogonal to a coupling direction of the second coupling section.

11. The assembly according to claim 9,
wherein a coupling direction of the first coupling section is opposite to a coupling direction of the second coupling section.

12. A robot device comprising a plurality of assemblies for a robot which are coupled in a successive manner,
wherein each of the assemblies comprises:
a main body with a coupling section,
wherein the coupling section has a first positioning section and a second positioning section, and
wherein the assembly is configured so that in a state where positioning has been performed by the first positioning section, positioning by the second positioning section is performed and the coupling section is coupled to another coupling section of another main body.
